(19) United States
(12) Patent Application Publication
(10) Pub. No.: US 2010/0200273 A1
(43) Pub. Date: Aug. 12, 2010

(54) CABLE ORGANIZER

(75) Inventors: Oliver Duncan Seil, Pasadena, CA (US); Chad DeJong, Los Angeles, CA (US); Nicolas Lehotzky, Pasadena, CA (US); David A. Kleeman, Marina del Rey, CA (US)

Correspondence Address: BRYAN CAVE LLP, TWO NORTH CENTRAL AVENUE, SUITE 2200, PHOENIX, AZ, 85004, US

(73) Assignee: Belkin International, Inc., Compton, CA (US)

(21) Appl. No.: 12/541,049

(22) Filed: Aug. 13, 2009

Related U.S. Application Data
(60) Provisional application No. 61/088,474, filed on Aug. 13, 2008.

(51) Int. Cl. H01B 7/00

(52) U.S. Cl. 174/135

(57) ABSTRACT

A cable organizer includes an upper surface, a lower surface, multiple channels, and at least one side surface. Other embodiments are disclosed herein.

### CROSS-REFERENCE TO RELATED APPLICATION

This application claims the benefit of U.S. Provisional Application No. 61/088,474, filed on Aug. 13, 2008 and entitled Cable Organizer, which is incorporated herein by reference.

### TECHNICAL FIELD

Subject matter described herein relates to electronic device accessories, and more particularly to the management of cables associated with electronic devices.

### BACKGROUND

Electronic devices of all types have become more and more common in everyday life. Electronic devices include non-portable devices as well as portable devices. Examples of non-portable electronic devices include wired telephones, routers (wired and wireless), wireless access points (WAPs) and the like. Examples of portable electronic devices include cellular phones, personal data assistants (PDAs), combination cellular phone and PDAs (e.g., a Blackberry® device available from Research in Motion (RIM®) of Ontario, Canada), cellular phone accessories (e.g., a Bluetooth® enabled wireless headset), MP3 players (e.g., an iPod® device by Apple Inc. (Apple®) of Cupertino, Calif.), compact disc (CD) players, and digital video disk (DVD) players. Along with the positive benefits of use of such devices comes the requirement to power the devices and/or communicate with them. Managing the power cables and data cables for such devices can prove difficult.

### BRIEF DESCRIPTION OF THE DRAWINGS

To facilitate further description of the embodiments, the following drawings are provided in which:

FIG. 1 is a prospective view illustrating an environment including aspects of the subject matter described herein;

FIG. 2 is a frontal view of an embodiment of the subject matter described herein;

FIG. 3 is a top, right, frontal isometric view of the embodiment of FIG. 2 of the subject matter described herein;

FIG. 4 is a bottom, left, frontal isometric view of the embodiment of FIG. 2 of the subject matter described herein;

FIG. 5 is an exploded, bottom, left, frontal isometric view of the embodiment of FIG. 2 of the subject matter described herein;

FIG. 6 is an exploded, top, left, frontal isometric view of the embodiment of FIG. 2 of the subject matter described herein;

FIG. 7 is a top, right, frontal isometric view of another embodiment of the subject matter described herein;

FIG. 8 is a frontal view of the embodiment of FIG. 7 of the subject matter described herein;

FIG. 9 is a top, right, frontal, isometric, partially see-through view of yet another embodiment of the subject matter described herein;

FIG. 10 is a top, right, frontal, isometric, partially see-through view of still another embodiment of the subject matter described herein; and

FIG. 11 is a flow chart illustrating a method of providing a cable organizer.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter. The aspects described above and other aspects of the subject matter described herein are illustrated by way of example and not limited in the accompanying figures in which like reference numerals indicate substantially similar elements.

For simplicity and clarity of illustration, the drawing figures illustrate the general manner of construction, and descriptions and details of well-known features and techniques may be omitted to avoid unnecessarily obscuring aspects of the subject matter described herein. Additionally, elements in the drawing figures are not necessarily drawn to scale. For example, the dimensions of some of the elements in the figures may be exaggerated relative to other elements to help improve understanding of embodiments of the subject matter described herein.

The terms “first,” “second,” “third,” “fourth,” and the like in the Detailed Description and in the claims, if any, are used for distinguishing between similar elements and not necessarily for describing a particular sequential or chronological order. It is to be understood that the terms so used are interchangeable under appropriate circumstances such that the embodiments of the subject matter described herein are, for example, capable of operation in sequences other than those illustrated or otherwise described herein. Furthermore, the terms “include,” and “have,” and any variations thereof, are intended to cover a non-exclusive inclusion, such that a process, method, system, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the Detailed Description and in the claims, if any, are used for descriptive purposes and not necessarily for describing permanent relative positions. It is to be understood that the terms so used are interchangeable under appropriate circumstances such that the aspects of the subject matter described herein are, for example, capable of operation in other orientations than those illustrated or otherwise described herein. The term “on,” as used herein, is defined as on, at, or otherwise substantially adjacent to or next to or over.

The terms “couple,” “coupled,” “couples,” “coupling,” and the like should be broadly understood and refer to connecting two or more elements or signals, electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable. For example, the recitation of a clip being coupled to an outer casing does not mean that the clip cannot be removed (readily or otherwise) from, or that it is permanently connected to, the outer casing.

### DETAILED DESCRIPTION OF EXAMPLES OF EMBODIMENTS

In a number of embodiments, a device includes: a base having an upper surface and a lower surface defining a substantially solid object; a first channel having a depth along a first axis, the first channel being disposed between the upper surface and the lower surface of the base; and a second channel having a width along a second axis, the second channel being disposed between the upper surface and the lower surface of the base. The second axis is substantially perpendicular to the first axis, and the second channel intersects the first channel. In these embodiments, the base can be trapezoidal and may further include: a front surface, the front surface disposed between the upper surface and the lower surface; a back surface, the back surface disposed between the upper surface and the lower surface; a first end surface, the first end surface disposed between the upper surface and the lower surface; and a second end surface, the second end surface disposed between the upper surface and the lower surface. The first channel and the second channel intersect the front surface, and the first channel and the second channel intersect the back surface. Furthermore, the base may additionally include a third channel having a depth along the first axis or an axis parallel to the first axis, the third channel being disposed between the upper surface and the lower surface of the base. The third channel intersects the first channel and the second channel; the third channel is sized to receive a head portion of a USB cable; and the first channel and the second channel are each sized to receive a cord portion of a USB cable, but not the head portion of a USB cable. Additionally, the base may also include a friction pad, the friction pad including a first friction pad surface and a second friction pad surface defining the friction pad, the first friction pad surface affixed to the lower surface of the base, the second friction pad surface having a coefficient of friction sufficient to reduce the movement of the base across a surface plane.

In another aspect of the subject matter described herein, a device includes: a base; a first slot through the base to pass the cord portion of a cable with the base restraining the head end of the cable from passing through the first slot; and a second slot through the base to pass a cord portion of a cable with the base permitting the head end of the cable to pass through the second slot. In these embodiments, axes along which the widths of the second slot and the first slot are disposed can be substantially parallel to one another. In other embodiments, the second slot intersects the first slot, and the widths of the first and second slots may be substantially perpendicular to one another.

In yet another aspect of the subject matter described herein, a device includes a base having: an upper surface portion, the upper surface portion having an external upper surface and an inside upper surface opposite the external upper surface; a side portion coupled to the upper surface portion; and a lower surface portion coupled to the side portion, the lower surface portion having an external lower surface and an inside lower surface opposite the inside upper surface, where the inside upper surface of the upper surface portion, the inside lower surface of the lower surface portion and the side portion of the base define a cavity. The device also includes at least one divider plane coupled to the inside lower surface of the lower surface portion. The divider plane and the inside upper surface of the upper surface portion define a cable access channel having a length and a width disposed along first and second axes, respectively, and the cable access channel is sized to receive a cord portion of a USB cable. The divider plane, the inside upper surface of the upper surface portion, and the inside lower surface of the lower surface portion define a cable management channel having a length and a width disposed along the first and second axes, respectively, or along other axes substantially parallel to the first and second axes, and the cable management channel is sized to receive a cord portion of a USB cable.

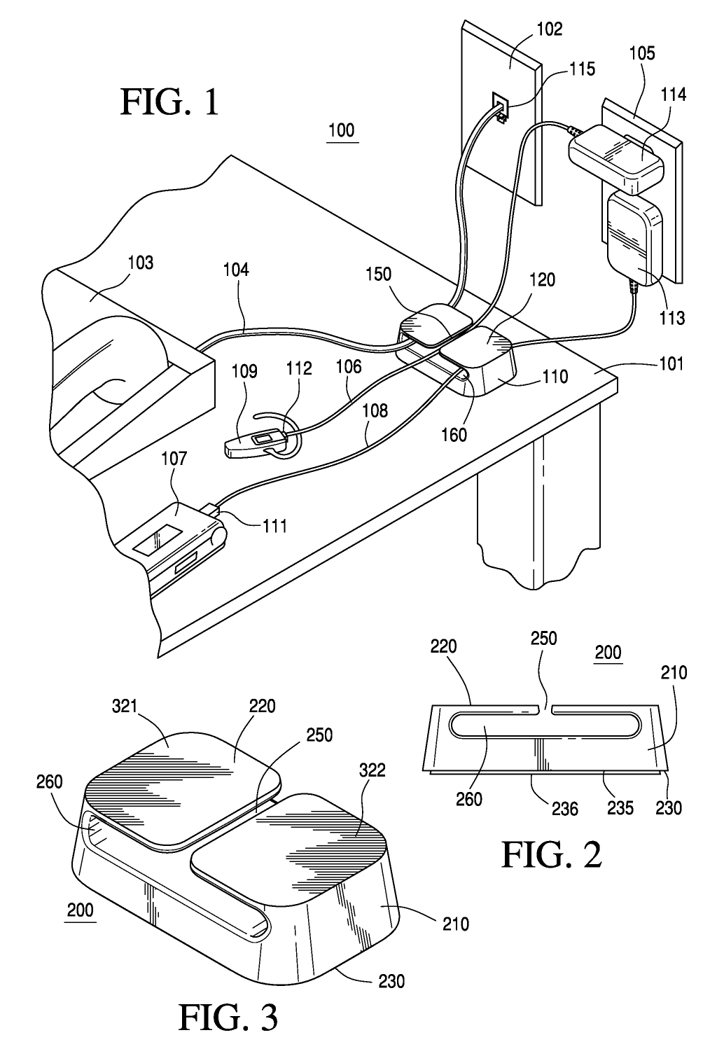

Turning to the drawings, FIG. 1 illustrates an environment 100 including a supported plane 101 upon which rests a wired telephone 103, a mobile electronic communication device 107, a mobile electronic communication device accessory 109, and a cable management device 110. Supported plane 101 may be implemented as any suitable supported plane, such as a desk or table (e.g., coffee table, end table, dining room table, office/den desk, and the like).

Telephone jack 102 is a communication gateway allowing wired telephone 103 to communicate with a public switched telephone network (PTSN) via telephone cable 104. In another embodiment, wired telephone 103 represents the wired base portion of a cordless telephone system operating by utilizing a frequency pair. In this embodiment, the wired base portion is in communication with a PTSN via telephone cable 104. Communication using wired telephones, as well as the wired base portion of a cordless telephone system, and PTSNs are know in the art and will not be discussed further. Electrical outlet 105 includes a plurality of alternating current (AC) outlets and is electrically coupled to a public electrical distribution system and provides power to mobile communication device 107 and mobile communication device accessory 109 via mobile communication device power cable 108 and mobile communication device accessory power cable 106, respectively. Mobile communication device power cable 108 includes a cord portion, a mobile device adaptor portion 111 sized to couple with mobile communication device 107 and an AC adapter portion 113 sized to couple with an AC outlet that is part of electric outlet 105. Mobile communication device accessory power cable 106 includes a cord portion, a mobile device accessory adaptor portion 112 sized to couple with mobile communication device accessory 109 and an AC adapter portion 114 sized to couple with an AC outlet that is part of electric outlet 105. Similarly, telephone cable 104 includes telephone device adapter portion (not shown) and a telephone jack adapter portion 115 sized to couple with telephone jack 102.

Telephone cable 104, mobile communication device accessory power cable 106, and mobile communication device power cable 108 are each sized so as to be managed by cable management device 110. Similarly, the device adapter portions and the AC adapter portions of power cables 106 and 108 as well as the device adapter portion and the telephone jack adapter portion 115 of telephone cable 104 are sized as to be neither managed by nor insertable into cable management device 110.

Cable management device 110 manages each of the cables by providing an area to store or locate the corded portion of each cable within cable management channel 160 via access channel 150. In operation, a user may manage her cables using cable management device 110 by passing the corded portion of a cable through access channel 150 and sliding the cable into cable management channel 160. Access channel 150 is located in upper surface 120 of cable management device 110.

Turning to FIGS. 2-4, FIGS. 2-4 illustrate an aspect of the subject matter described herein which may function as a cable management device. FIG. 2 is a frontal view of an aspect of cable management device 200. Cable management device 200 includes a base 210 portion having an upper surface 220 and a lower surface 230. Base 210 further includes access channel 250 located between upper surface 220 and a lower surface 230. Access channel 250 intersects upper surface 220 as well as the front and back of base 210. A length of access channel 250 is measured from the front to back (or vice versa) of cable management device 200. When a cable is inserted into access channel 250, the corded portion of the cable generally runs along the length of access channel 250. A depth of access channel 250 is perpendicular to the length of access channel 250, and in the embodiment illustrated in FIG. 2, the depth of access channel 250 extends from the top towards the bottom (or vice versa) of cable management device 200. The depth of access channel 250 is disposed along a first axis that can be substantially perpendicular to upper surface 220 of base 210. In other embodiments, the depth of access channel 250 is disposed along a first axis that is not substantially perpendicular to upper surface 220, but access channel 250 still intersects upper surface 220. The width of access channel 250 is perpendicular to the length and the depth of access channel 250, and in the embodiment illustrated in FIG. 2, the width of access channel 250 extends from the left side towards the right side (or vice versa) of cable management device 200. Access channel 250 may be sized having any suitable width for receiving corded portions of suitable cables. In an example, access channel 250 has a channel width of 4 millimeters (mm) that is measured along an axis substantially parallel to upper surface 220.

Base 210 additionally includes cable management channel 260 located between upper surface 220 and a lower surface 230, and intersects access channel 250. In the illustrated embodiment of cable management device 200, the length, height, and width of cable management channel 260 extend in similar directions as the length, height, and width, respectively, of access channel 250. As an example, a width of cable management channel 260 is disposed along a second axis that is substantially perpendicular to the first axis along which the depth of access channel 250 is disposed, and the second axis also can be substantially parallel to upper surface 220. In other embodiments, a width of cable management channel 260 is disposed along a second axis that is not substantially perpendicular to the first axis along which the depth of access channel 250 is disposed. Cable management channel 260 may be sized having any suitable height or depth for receiving suitable cables. In an example, cable management channel 260 has a channel height/depth larger than the channel width of access channel 250. In this example, the channel height of cable management channel 260 can be 7 mm. In the same or different example, the channel height or depth of cable management channel 260 is at least twice as large as the diameter of a cord portion of a suitable cable. In this example, any cable within cable management channel 260 can be removed from cable management channel (and access channel 250) without having to first remove any cord portions of any other cables being simultaneously managed by cable management device 200.

Cable management device 200 may additionally include an optional friction pad 235 coupled to lower surface 230 and having at least one friction surface 236. In some embodiments, friction surface 236 reduces the movement of base 210 on a surface where it is located.

In operation, a user may manage her cables using cable management device 210 by passing the corded portion of a cable through access channel 250 and sliding the corded portion of cable into cable management channel 260. Base 210 can be manufactured from any suitable material, such as one or more polymers, plastics, metals, and alloys. In an example, base 210 can be manufactured from a polycarbonate. In another example, base 210 can be manufactured using any suitable injection molding process. Furthermore, base 210 can be molded or cast as a single piece, or manufactured in numerous pieces taking one or more forms and then assembled as base 210.

FIG. 3 is a top, right, frontal isometric view of another aspect of cable management device 200. As described above, cable management device 200 includes base 210 having upper surface 220 and lower surface 230. In some embodiments, upper surface 220 includes left upper surface portion 321 and right upper surface portion 322 that are formed between the upper surface of cable management channel 260 and upper surface 220. In such embodiments, the gap between upper surface portion 321 and right upper surface portion 322 defines access channel 250. In one embodiment, left upper surface portion 321 and right upper surface portion 322 are formed during the manufacturing process so as to be flexible, thereby allowing cables having a diameter greater that the width of access channel 250 to be forcibly maneuvered through access channel 250 to reach cable management channel 260. When such an embodiment is implemented, access channel 250 provides a retention function thereby securing the corded portion of the cables within cable management device 200.

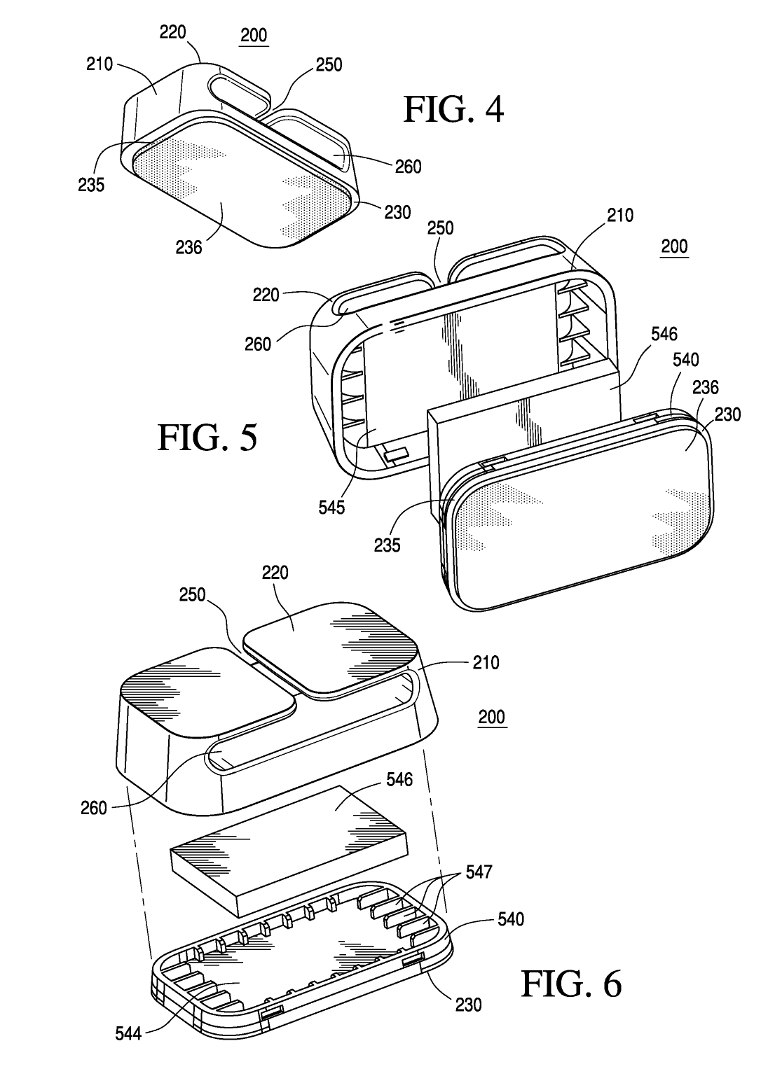

FIG. 4 is a bottom, left, frontal isometric view of an aspect of cable management device 200. As described earlier, cable management device 200 includes base 210 having upper surface 220 and lower surface 230, and base 210 further includes friction pad 235 coupled to lower surface 230 and having at least one friction surface 236. Friction pad 235 and friction surface 236 can be manufactured from any suitable material or materials whereby friction surface 236 includes a coefficient of friction sufficient to reduce the movement of cable management device 200 across a surface. In an example, the material or materials used to manufacturer friction pad 235 and friction surface 236 have a coefficient of friction sufficient to reduce the movement of cable management device 200 across a surface. In another example, a texture is mechanically or chemically applied to friction surface 236 to produce a suitable coefficient of friction.

Friction pad 235 can be coupled to lower surface 230 using any suitable process or material. In an example, friction pad 235 is affixed to lower surface 230 using a suitable bonding substance, such as, an adhesive. In another example, friction pad 235 is mounted to lower surface 230 using mechanical techniques, such as staples, nails, and the like. In yet another example, friction pad 235 is thermally coupled to lower surface 230 using any suitable thermal bonding methodology.

In other embodiments, friction pad 235 and friction surface 236 can be manufactured as part of cable management device 200, for example in a portion of the same mold using a substantially similar or different material. In an example, manufacturing friction pad 235 using substantially similar material as base 210 and mechanically applying a texture to friction surface 236 produces a suitable coefficient of friction.

Turning to FIGS. 5 & 6, FIGS. 5 & 6 illustrate another aspect of the subject matter described herein which may function as a cable management device. FIG. 5 is an exploded, bottom, frontal isometric view of yet another aspect of cable management device 200. FIG. 6 is an exploded, top, left, frontal isometric view of still another aspect of cable management device 200. As explained above, cable management device 200 includes base 210 having upper surface 220. In the embodiment illustrated in FIGS. 5 & 6, base 210 is a multi piece base having upper surface 220 and a detachable lower portion 540. Lower portion 540 includes lower surface 230 and friction pad 235 having friction surface 236. Detachable lower portion 540 is sized to couple to the upper portion of base 210 that includes upper surface 220. In some embodiments, detachable lower portion 540 is sized to mechanically couple to the upper portion of base 210. In other embodiments, detachable lower portion 540 is sized to be affixed to the upper portion of base 210, for example via chemical or thermal techniques.

Access channel 250 is located between upper surface 220 and detachable lower portion 540. Cable management channel 260 is located between upper surface 220 and detachable lower portion 540.

Base 210 further includes cavities 544 and 545 located within base 210. Cavities 544 and 545 are also located within detachable lower portion 540 and the upper portion of base 210, respectively. Cavities 544 and 545 are sized to receive a weight 546, and weight 546 is sized fit within cavities 544 and 545. In some embodiments, cavity 544 includes ridges 547 along the internal circumference of cavity 544 sized and positioned to securely contain weight 546. Weight 546 can be manufactured in any suitable shape sized to fit within cavities 544 and 545, for example a rectangular shape, an elliptical shape, and the like. Weight 546 provides increased stability to cable management device 200. In some embodiments, weight 546 and friction surface 236 provide an increased coefficient of friction to reduce the movement of cable management device 200 across a surface. Weight 546 can be manufactured from any suitable material, such as one or more polymers, plastics, metals, and alloys. In an example, weight 546 is manufactured using zinc plated with stainless steel.

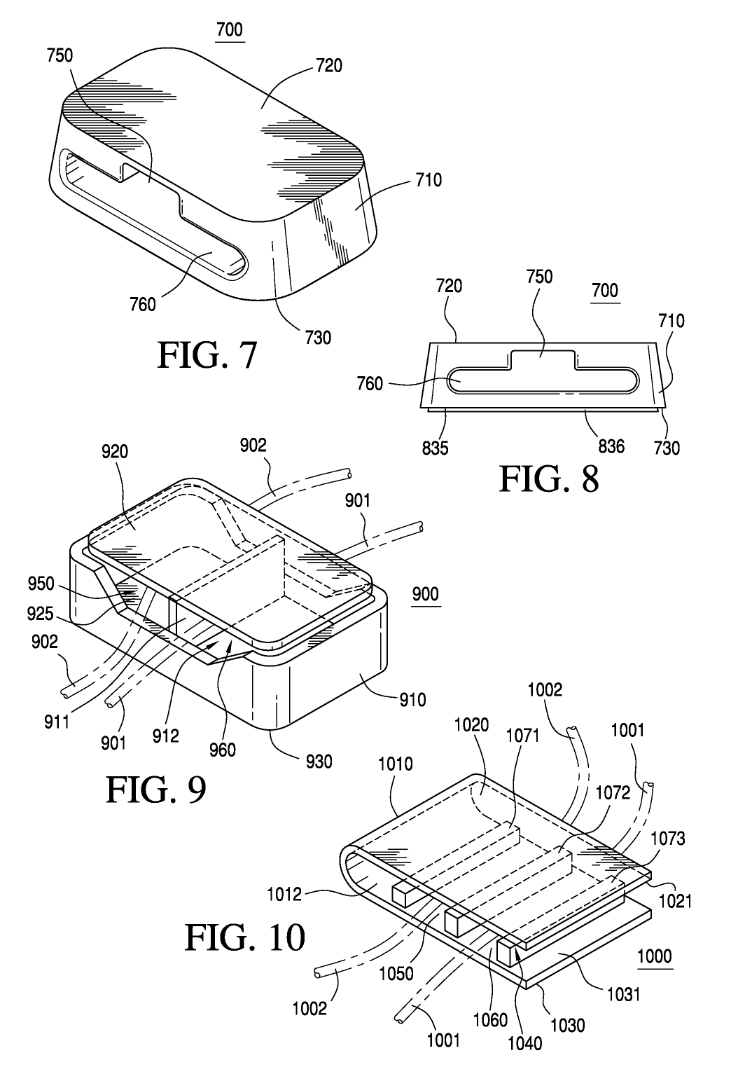

Turning to FIGS. 7 & 8, FIGS. 7 & 8 illustrate an aspect of the subject matter described herein which may function as a cable management device. FIG. 7 is a top, right, frontal isometric view of another embodiment of a cable management device, namely, cable management device 700. Cable management device 700 includes a base 710 having an upper surface 720 and a lower surface 730. Base 710 further includes cable management channel 760 located between upper surface 720 and lower surface 730. Cable management channel 760 has a length along which corded portions of cables generally lie when the cables are managed by cable management channel 760. The length of cable management channel 760 is disposed along a first axis that is substantially parallel to upper surface 720 and intersects the front and back of base 710. In other embodiments, the length of cable management channel 760 is disposed along a first axis that is not substantially parallel to upper surface 720. Cable management channel 760 may be sized having any suitable width for receiving suitable cables. In an example, cable management channel 760 has a channel height of 4 mm, 7 mm, or at least twice as large as the diameter of a cord portion of a suitable cable.

Base 710 additionally includes access channel 750 located between upper surface 720 and lower surface 730 and intersecting cable management channel 760. In the illustrated embodiment of cable management device 700, the length, width, and depth of access channel 750 extend in similar directions as the length, width, and depth, respectively, of cable management channel 760. The depth of access channel 750 is disposed along a second axis substantially perpendicular to upper surface 720. In other embodiments, the depth of access channel 750 is disposed along a second axis that is not substantially perpendicular to upper surface 720. In some embodiments, access channel 750 may be sized having any suitable width for receiving device adapter portions as well as corded portions of suitable cables. In other embodiments, access channel 750 may be sized such that the combination of access channel 750 and cable management channel 760 is sized for receiving device adapter portions as well as corded portions of suitable cables, but where each of access channel 750 and cable management channel 760, alone, are not large enough to receive device adapter portions of the cables. In the same or different embodiments, cable management channel 760 can have features similar to those features described previously for cable management channel 260 with respect to FIGS. 2-6.

In operation, a user may manage her cables using cable management device 700 by passing the device adapter portion of a cable through base 710 via access channel 750 or at the intersection of access channel 750 and cable management channel 760, and sliding the corded portion of the cable into cable management channel 760. Base 710 can be manufactured from any suitable material, such as one or more polymers, plastics, metals, and alloys. In an example, base 710 can be manufactured from a polycarbonate. In another example, base 710 can be manufactured using any suitable injection molding process. Furthermore, base 710 can be manufactured in numerous pieces taking one or more forms and then assembled as base 710. In other embodiments, base 710 can be modified as described in FIGS. 5 and 6, above.

FIG. 8 is a frontal view of yet another aspect of cable management device 700. As described previously, cable management device 700 includes base 710 portion having an upper surface 720 and a lower surface 730. As shown in the embodiment illustrated in FIG. 8, the widths of access channel 750 and cable management channel 760 extend from the right side towards the left side (or vice versa) of cable management device 700, and the depths or heights of access channel 750 and cable management channel 760 extend from the top towards the bottom (or vice versa) of cable management device 700. Base 710 further includes friction pad 835 coupled to lower surface 730 and having at least one friction surface 836. Friction surface 836 can be manufactured from any suitable material or materials that include a coefficient of friction sufficient to reduce the movement of cable management device 700 across a surface. Friction pad 835 can be coupled to lower surface 730 using any suitable process or material. In an example, friction pad 835 can be affixed to lower surface 730 using any suitable bonding substance, such as, an adhesive. In another example, friction pad 835 can be mounted to lower surface 730 using mechanical means, such as staples, nails, and the like. In yet another example, friction pad 835 can be thermally coupled to lower surface 730 using any suitable thermal bonding methodology.

In other embodiments, friction pad 835 can be manufactured as part of cable management device 700, for example in a portion of the same mold using a substantially similar or different material. In an example, manufacturing friction pad 835 using substantially similar material as base 710 and mechanically applying a texture to friction surface 836 of friction pad 835 produces a suitable coefficient of friction. Except as otherwise indicated, the elements of cable management device 700 in FIGS. 7 & 8 having reference numbers with the same least two significant digits as the elements of cable management device 200 in FIGS. 2-6 can be similar to each other. For example, lower surface 730 in FIGS. 7 & 8 can be similar to lower surface 230 in FIGS. 2-6, and friction pad 835 in FIG. 7 & 8 can be similar to friction page 235 in FIGS. 2-6. In other embodiments, even where not expressly indicated, elements in FIGS. 7 & 8 with a different most significant digit, but the same least two significant digits, as elements in FIGS. 2-6 can be different from each other.

Turning to FIG. 9, FIG. 9 illustrates yet another aspect of the subject matter described herein which may function as a cable management device. FIG. 9 is a top, right, frontal, isometric, and partially see-through view of an aspect of a cable management device 900. Cable management device 900 includes a base 910 having a lower surface 930, an inside surface 925 and an upper plane 920 defining a cavity 912. Base 910 further includes a divider plane 911 that divides cavity 912 into: (1) a first channel 950 having a width disposed along a first axis substantially parallel to upper plane 920; and (2) a second channel 960 having a width disposed along the first axis. A length of second channel 960 disposed along another axis that is substantially parallel to an axis along which a length of first channel 950 is disposed. FIG. 9 additionally includes cable 901 and cable 902 which are managed by cable management device 900. Cables 901 and 902 are located within cavity 912, but the see-through portion of cable management device 900 does not show cables 901 and 902. Cables 902 and 901 generally run along the lengths of first channel 950 and second channel 960, respectively.

In some embodiments, base 910 may be manufactured as a single piece from any suitable material, such as one or more polymers, plastics, metals, and alloys. In an example, base 910 can be manufactured from a polycarbonate. In another example, base 910 can be manufactured using any suitable injection molding process. In some embodiments, upper plane 920 is coupled to base 910 and first channel 950 and second channel 960 are sized having any suitable width for receiving device adapter portions as well as corded portions of suitable cables.

In other embodiments, base 910 can be manufactured in numerous pieces taking one or more forms and then assembled as base 910. In an example and illustrated in FIG. 9, upper plane 920 is affixed to divider plane 911 which may be manufactured as part of base 910 or separately and then affixed to base 910. In another example, divider plane 911 and upper plane 920 are sized such that upper plane 920 is not in normally in physical communication with base 910. In this example, divider plane 911 is flexible so that when a user applies a downward force to one end of upper plane 920, divider plane 911 can bend slightly so that a gap appears between the opposite end of upper plane 920 and base 910, which allows for the passage of a corded portion of a cable into the channel (i.e., first channel 950 or second channel 960) that is located at the opposite end of upper plane 920. In other embodiments, base 910 can be modified as described with respect to FIGS. 5 and 6, above.

Turning to FIG. 10, FIG. 10 illustrates still another aspect of the subject matter described herein which may function as a cable management device. FIG. 10 is a top, right, frontal, isometric, partially see-through view of still another embodiment of a cable management device, namely, cable management device 1000. Cable management device 1000 includes a base 1010 having an upper surface 1020, an inside upper surface 1021, a lower surface 1030 and an inside lower surface 1031. Cable management device 1000 additionally includes divider planes 1071-1073 coupled to inside lower surface 1031, and having heights disposed along first axes that are substantially parallel to one another and substantially perpendicular to inside upper surface 1021 and inside lower surface 1031, and each having a height that is smaller than a distance between inside upper surface 1021 and inside lower surface 1031 to allow a corded portion of a cable to pass between inside upper surface 1021 and the top surfaces of divider planes 1071-1073. Cable access channel 1040 has a length and a width that are disposed in a first plane substantially parallel to upper surface 1020, and cable access channel 1040 intersects a side as well as the front and back of base 1010. Divider planes 1071-1073 are spaced so as to form: an access cavity 1012 between divider plane 1071 and base 1010; a first cable management channel 1050 between divider planes 1071-1072; a second cable management channel 1060 between divider planes 1072-1073; and a cable access channel 1040 between divider plane 1073 and an end of base 1010. In some embodiments, cable access channel 1040 is utilized as a third cable management channel.

Base 1010 can be manufactured from any suitable material, such as one or more polymers, plastics, metals, and alloys. In an example, base 1010 can be manufactured from a polycarbonate. In another example, base 1010 can be manufactured using any suitable injection molding process. Furthermore and as described above, base 1010 can be manufactured in numerous pieces taking one or more forms and then assembled as base 1010. In some embodiments, cavity 1012 is filled with the same material used to manufacture base 1010 thereby removing its functionality. In other embodiments, divider planes 1071-1073 can be manufactured as part of base 1010. In still other embodiments, divider planes 1071-1073 can be manufactured together as a single piece and affixed to inside lower surface 1031 of base 1010. In other embodiments, divider planes 1071-1073 can be manufactured separately and each affixed to inside lower surface 1031 of base 1010.

In operation, a user may manage her cables using cable management device 1010 by passing the corded portion of a cable, such as, for example, cable 1001 or cable 1002, through cable access channel 1040 and sliding the corded portion of the cable over divider planes 1072 and/or 1073 and into first cable management channel 1050 or second cable management channel 1060. In another embodiment, a user may manage her cables using cable management device 1010 by passing the device adapter portion of a cable into and through access cavity 1012 between divider plane 1071 and base 1010, and further sliding the corded portion of the cable over divider planes 1071 and/or 1072 from access cavity 1012 into first cable management channel 1050 or second cable management channel 1060. In an additional embodiment, the height of divider planes 1071-1073 can be substantially the same as the distance between inside upper surface 1021 and inside lower surface 1031. In this additional embodiment, upper surface 1030 of base 1010 and/or or the curved end portion of base 1010 can comprise a flexible material such that a user can manually separate or lift inside upper surface 1021 away from the top surfaces of divider planes 1071-1073 to permit sliding the corded portion of a cable into first cable management channel 1050 or second cable management channel 1060 from cable access channel 1040.

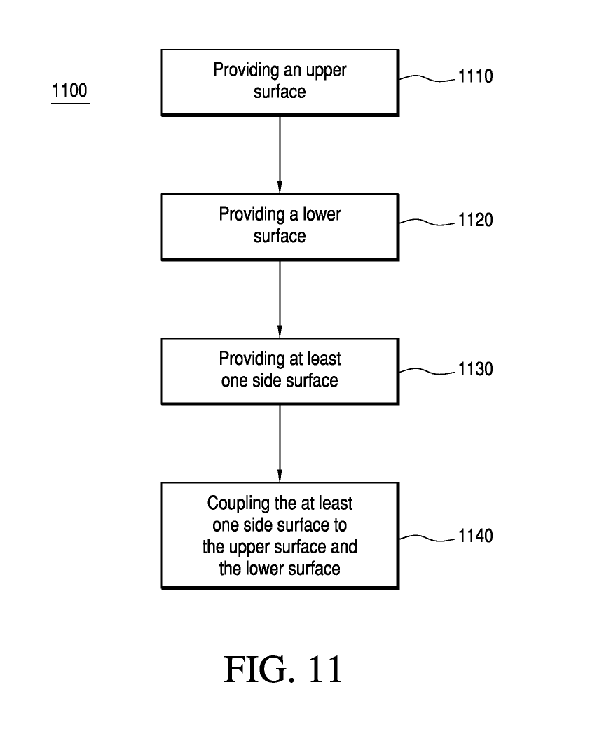

FIG. 11 illustrates an example of a method 1100 of providing a cable organizer. Method 1100 comprises a procedure 1110 of providing an upper surface. As an example, the upper surface can be upper surface 220 (FIG. 2), upper surface 720 (FIG. 7), upper surface 920 (FIG. 9), or upper surface 1020 (FIG. 10).

Next, method 1100 continues with a procedure 1120 of providing a lower surface. As an example, the lower surface can be lower surface 230 (FIG. 2), lower surface 730 (FIG. 7), lower surface 930 (FIG. 9), or lower surface 1030 (FIG. 10).

After procedure 1120, method 1100 continues with a procedure 1130 of providing at least one side surface and an optional procedure 1140 of coupling the at least one side surface to the upper surface and the lower surface. After the at least one side surface has been coupled to the lower surface and the upper surface, a base is formed. As an example, the base can be base 201 (FIG. 2), base 710 (FIG. 7), base 910 (FIG. 9), or base 1010 (FIG. 10).

In addition, a first channel and a second channel can be formed in the base after the at least one side surface is coupled to the upper surface and the lower surface. As an example, the first and second channel can be channels 260 and 250 (FIG. 2), channels 760 and 750 (FIG. 7), channels 960 and 950 (FIG. 9), or channels 1050 and 1060 (FIG. 10). In one example, the first channel has a depth along a first axis and the second channel has a width along a second axis; and the second axis can be substantially perpendicular to the first axis.

After procedure 1140, method 1100 is complete. It should be noted that method 1100 can have additional procedures, such as, for example, providing a friction pad and/or a weight. In addition, the order of the procedures of method 1100 can be rearranged. For example, procedures 1110 through 1130 can be in any order.

Although aspects of the subject matter described herein have been described with reference to specific embodiments, it will be understood by those skilled in the art that various changes may be made without departing from the scope of the subject matter described herein. Accordingly, the disclosure of embodiments is intended to be illustrative of the scope of the subject matter described herein and is not intended to be limiting. It is intended that the scope of the subject matter described herein shall be limited only to the extent required by the appended claims. To one of ordinary skill in the art, it will be readily apparent that the devices and method discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the subject matter described herein and claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A cable organizer, comprising:
a base comprising:
an upper surface; and
a lower surface;
a first channel having a first depth along a first axis; and
a second channel having a first width along a second axis;
wherein:
the first channel and the second channel are disposed between the upper surface and the lower surface;
the second axis is substantially perpendicular to the first axis.

2. The cable organizer of claim 1, wherein:
the second channel intersects the first channel.

3. The cable organizer of claim 1, wherein:
the base comprises a substantially solid object.

4. The cable organizer of claim 3, wherein:
the base comprises a shape that is trapezoidal.

5. The cable organizer of claim 1, further comprising:
a friction pad coupled to the lower surface.

6. The cable organizer of claim 5, further comprising:
a weight, wherein the weight and the friction pad increase a coefficient of friction between a surface and the cable organizer.

7. The cable organizer of claim 1, wherein:
the upper surface comprises a left portion and a right portion; and
the first channel has a second width that is defined by a distance between the left portion and the right portion.

8. The cable organizer of claim 7, wherein:
at least one of the right portion or the left portion is flexible so that a cable with a diameter greater than the second width can pass through the first channel.

9. A cable organizer, comprising:
a base comprising;
an upper surface; and
a lower surface;
a first slot; and
a second slot;
wherein:
the first slot has a first width along a first axis;
the second slot has a second width along a second axis; along
the second slot intersects the first slot.

10. The cable organizer of claim 9, wherein:
the first axis is substantially parallel to the second axis.

11. The cable organizer of claim 9, wherein:
the first axis is substantially parallel to the upper surface.

12. The cable organizer of claim 9, wherein:
the first slot has a first depth;
the first depth is large enough to receive a cord of cable; and
the first depth is smaller than a head of the cable.

13. The cable organizer of claim 9, wherein:
the second slot has a second depth; and
the second depth is large enough to receive a head of a cable.

14. The cable organizer of claim 9, further comprising:
a friction pad coupled to the lower surface.

15. A cable organizer, comprising:
a base comprising:
an upper surface; and
a lower surface;
at least one divider plane that is coupled to at least one of the upper surface or the bottom surface;
at least one side surface; and
at least two channels.

16. The cable organizer of claim 15, wherein:
the at least one divider plane comprises a first divider plane coupled to the lower surface and the upper surface.

17. The cable organizer of claim 16, wherein:
the upper surface is flexible so that a cable can pass through a gap between the upper surface and the at least one side surface if the cable has a diameter that is greater than a height of the gap.

18. The cable organizer of claim 16, wherein:
the at least two channels comprises a first channel and a second channel;
the first channel is formed between the first divider plane and a first one of the at least one side surface; and
the second channel is formed between the first divider plane and a second one of the at least one side surface.

19. The cable organizer of claim 15, wherein:
the at least one divider plane comprises:
a first divider plane coupled to the lower surface;
a second divider plane coupled to the lower surface; and
a third divider plane coupled to the lower surface; and
the at least one side surface comprises a first side surface.

20. The cable organizer of claim 19, wherein:
the at least two channels comprise a first channel and a second channel;
the first channel is formed between the first divider plane and the second divider plane; and
the second channel is formed between the second divider plane and the third divider plane.

21. The cable organizer of claim 20, further comprising:
a first gap between the third divider plane and the upper surface; and
a second gap between the second divider plane and the upper surface.

22. The cable organizer of claim 21, wherein:
the upper surface is flexible so that a cable that has a diameter that is greater than a height of the first gap and a height of the second gap can pass through the first gap and the second gap.

23. A method of providing a cable organizer, comprising:
providing an upper surface;
providing a lower surface;
providing a first side surface; and
providing a second side surface;
wherein:
a first channel and a second channel are present;
the first channel having a depth along a first axis;
the second channel having a width along a second axis; and
the second axis is substantially perpendicular to the first axis.

24. The method of claim 23, further comprising:
providing a friction pad; and
coupling the friction pad to the lower surface.
